(19) United States
(12) Patent Application Publication
(10) Pub. No.: US 2014/0246914 A1
(43) Pub. Date: Sep. 4, 2014

(54) Sub-Synchronous Oscillation Damping By Shunt Facts Apparatus

(71) Applicants: Rajiv Chopra, Skillman, NJ (US); Reginald Mendis, Audubon, PA (US); Marek Furyk, Boyertown, PA (US)

(72) Inventors: Rajiv Chopra, Skillman, NJ (US); Reginald Mendis, Audubon, PA (US); Marek Furyk, Boyertown, PA (US)

(73) Assignee: ALSTOM TECHNOLOGY LTD., CH-5400 Baden (CH)

(21) Appl. No.: 14/237,364

(22) PCT Filed: Sep. 12, 2012
(86) PCT No.: PCT/EP2012/067868

§ 371 Date: Mar. 25, 2014

Related U.S. Application Data
(60) Provisional application No. 61/533,450, filed on Sep. 12, 2011.

(51) Int. Cl. H02J 3/24

(52) U.S. Cl. CPC H02J 3/24
USPC 307/84

(57) ABSTRACT

A power distribution system comprising a point of common connection that receives electric power supplied by a first power generation system and a second generation system, with the second power generation system that comprises a renewable electric power generator; a transmission line operatively connected to the point of common connection for conducting the electric power between the point of common connection and an external AC electric network. The power distribution furthermore comprises a capacitive compensator connected in series with the transmission line to compensate for a reactive power component of the electric power conducted by the transmission line; and a shunt arranged flexible AC transmission system that mitigates a sub-synchronous resonance effect caused at least in part by the capacitive compensator. A flexible AC transmission system controller of the flexible AC transmission system comprises a damping effect on sub-synchronous oscillations included in the sub-synchronous resonance.

### TECHNICAL FIELD

The invention relates to electricity transmission and more precisely to power distribution systems used for the transmission of electricity power.

### PRIOR ART

Concerning power distribution systems that connect wind farm generators, sub-synchronous resonance phenomena have been identified as a potential problem where transmission lines are compensated with series capacitor banks where potential damage may occur in power plant generators. The subject was first identified in the early 1970s and has gained more prominence in recent years with the increased application of series capacitor banks for transmission line optimization. This is especially true now in the case of renewable energy integration where multiple series capacitor banks are utilized near wind farm generators.

The frequency sub-synchronous resonance range is defined as inferior to the fundamental frequency that is usually 60 Hz.

The sub-synchronous resonances may come from interactions between thermal generators, and/or wind farm generators and a series compensated transmission lines that include series of capacitor banks. These interactions can be categorized in three different groups:
induction generator effect,
torsional interactions, and
device dependent, like high voltage direct current controller interaction, power system stabilizer interactions . . . .

In power distribution systems that receive electric power supplied by wind farm generators, series compensated transmission has the potential to produce sub-synchronous interactions with the wind farm generators that are caused by self excitation due to induction generator effect. This is particularly the case for doubly fed induction generator (known as type 3) wind generator type and also observed for fixed speed (known as type 1) and wound rotor with external resistor (known as type 2) wind generator types.

To overcome this kind of sub-synchronous interaction and resonance many solutions exist. It is known, for example, to implement, in the power distribution system, devices like thyristor controlled series capacitors, series capacitor bypass filter, series of blocking filter, supplementary excitating damping control for generator, synchronous machine frequency relay or sub-synchronous machine frequency relay and sub-synchronous oscillation relay.

But all these devices are expensive and need to be specifically design for each installation. This kind of solution increases significally the cost of a power distribution system modified in accordance to one of these solutions.

It is also know from prior art to overcome the problem of sub-synchronous interactions and resonances to modify the wind farm generators. This kind of modification of each wind generators is particularly costly.

### SUMMARY OF THE INVENTION

An object of this invention is to overcome these difficulties.

More precisely one object of the invention is to provide a power distribution system with mitigated sub-synchronous interactions and resonances in an electric transmission networks that are due to the installation of series compensation, as fixed series capacitor banks, affecting exiting generation, including wind generators, that is less expensive than a power distribution system according prior art solutions.

A power distribution system according to the invention is a power distribution system that comprises:

a point of common connection that receives electric power supplied by a first power generation system and a second generation system, wherein the second power generation system comprises a renewable electric power generator;

a transmission line operatively connected to the point of common connection for conducting the electric power between the point of common connection and an external AC electric network;

a capacitive compensator connected in series with the transmission line to compensate for a reactive power component of the electric power conducted by the transmission line; and

a shunt arranged flexible AC transmission system that mitigates a sub-synchronous resonance effect caused at least in part by the capacitive compensator, wherein a flexible AC transmission system controller comprises a damping effect on sub-synchronous oscillations included in the sub-synchronous resonance.

The configuration of the invention provides an universal and independent solution that can be applied on any power distribution system that comprises a point of common connection that receives electric power supplied by at least a renewable electric power generator. This solution is flexible and does not need costly adaptation as the prior art solutions. This is a solution that is less expensive than existing conventional solutions. Furthermore, this solution can be applied at a strategically chosen/defined location to mitigate multiple issues with multiple series capacitor banks compared to having individual solutions for each installation of fixed series capacitor banks. Another advantage of the invention is that, in case of power distribution system parameters change, and a movement of sub-synchronous interaction problems, it is easily possible to relocate the shunt in a different location and to modify the flexible AC transmission system controller.

The damping component may integrally be formed as part of the flexible AC transmission system controller.

The flexible AC transmission system controller may be a static VAR compensator or a static synchronous compensator.

The flexible AC transmission system controller may be a static VAR compensator, and the damping component comprises a damping loop that:

(i) Receives, as an input, a signal indicative of the electric power supplied by at least one of the first and second power generator system,

(ii) Performs a comparison of the signal to a reference signal, and

(iii) Transmits an output signal based on the comparison to the static VAR compensator.

Such flexible AC transmission system controller uses a local signal, the signal indicative of the electric power, and does not require, as many of prior art solutions, a remote signal to mitigate sub-synchronous oscillation.

The damping component may establish a damping ratio of at least about 3%.

The invention also relates to a shunt-arranged flexible AC transmission system controller comprising:

a resonance component that mitigates a sub-synchronous resonance effect caused at least in part by a capacitive compensator electrically connected, in series, to a transmission line; and

a damping component that imparts a damping effect on sub-synchronous oscillations included in the sub-synchronous resonance that have frequencies less than a fundamental frequency of the electric power conducted by the transmission line.

### BRIEF DESCRIPTION OF THE DRAWINGS

Other characteristics and advantages of the invention will appear on reading the detailed description given below and for the understanding of which reference is made to the accompanying drawings, in which:

FIG. 1 diagrammatically illustrates an example of a power distribution system from a first embodiment of the invention,

FIG. 2 illustrates an example of sub-synchronous oscillation damping from the power distribution system illustrated on FIG. 1,

FIG. 3 diagrammatically illustrates an example of an power distribution system according to a second embodiment of the invention that comprises two different types of wind generator farms,

FIG. 4 diagrammatically illustrates an sub-synchronous damping loop from an power distribution system as illustrate in FIG. 3,

FIGS. 5a to 5e illustrate respectively simulation of the active power, the reactive power, the rotor speed, the static VAR compensator power and the 345 kV bus voltage, variation with and without and static VAR compensator as the invention.

### DETAILED DESCRIPTION OF PARTICULAR EMBODIMENTS

Damping is generally defined by the damping ratio. The damping ratio determines the rate of decay of the amplitude of the oscillations. With a 1% damping ratio, it takes about 15 cycles to decay to ⅓rd of the initial amplitude. If the damping ratio is 5% it takes only 3 cycles to decay to ⅓rd of the initial amplitude. For the electromechanical oscillations, the damping ratios of 5% or above are generally accepted. In some electric utilities, the critical value is around 3%.

A power distribution system according to the invention comprises:

a point of common connection that receives electric power supplied by a first power generation system and a second generation system,

a transmission line operatively connected to the point of common connection for conducting the electric power between the point of common connection and an external AC electric network;

a capacitive compensator connected in series with the transmission line to compensate for a reactive power component of the electric power conducted by the transmission line; and

a shunt arranged flexible AC transmission system that mitigates a sub-synchronous resonance effect caused at least in part by the capacitive compensator, wherein the flexible AC transmission system controller comprises a damping effect on sub-synchronous oscillations included in the sub-synchronous resonance.

The second power generation system comprises a renewable electric power generator as a wind generator or another type of renewable electric power generator that could generate sub-synchronous resonance by interact with the series compensated transmission line that comprises the transmission line.

Now follows a description of two examples of possible embodiments according to the invention that have been simulated.

In these simulations, the condition had been as follow:
the impedance seen at the generator neutral has been scanned through the sub-synchronous frequency range and mainly used as a screening tool,
detailed models of the system have been used to produce simulations with very accurate results.

Concerning the simulation tools that have been used, the use of simplified models of the various power system components and large systems can accurately simulate in a shorter time and gives an insight into the dynamic behavior of the system. For large systems, it requires a long time to simulate and it was difficult to identify the cause of the sub-synchronous resonance instability.

To simulate more accurately a power installation in particular, proper impedance characteristics of induction generators are required.

### EXAMPLE 1

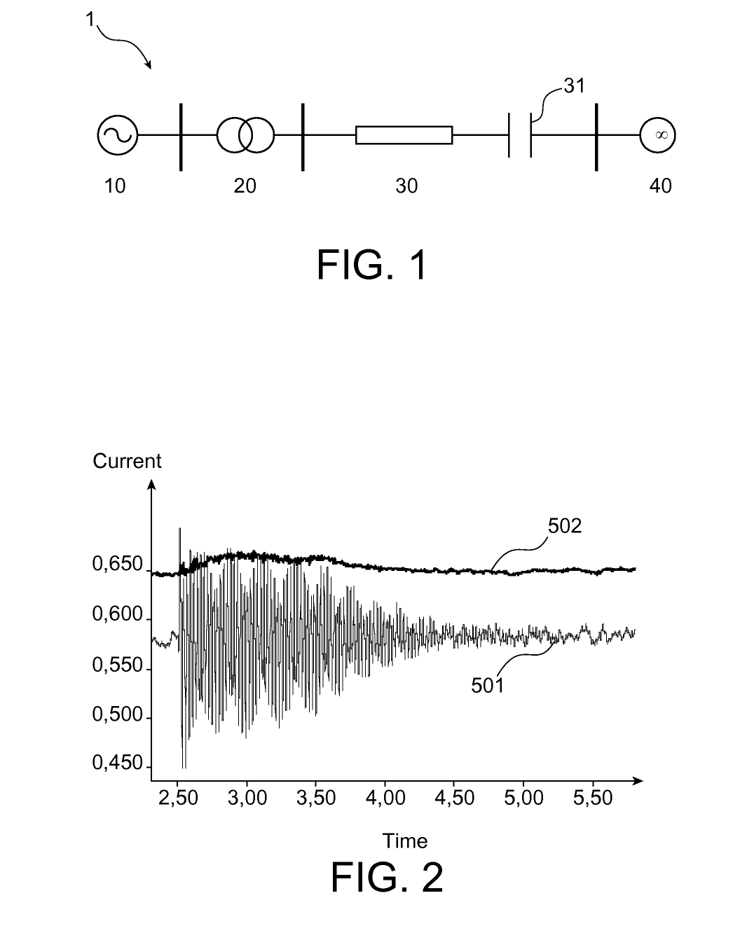

### A Basic Installation as Illustrated in FIG. 1

FIG. 1 illustrates a first installation 1 that comprises a power distribution system according to the invention. This installation comprises:
200 MW wind farm 10,
a point of common coupling transformer 20 connected to the 200 MW wind farm,
a 200 km series compensated transmission line 30 of 230 kV at which the 200 MW wind farm is radially connected to the 200 MW wind farm thanks to the point of common coupling transformer 20, the transmission line 30 comprising a series capacitor 31 with a bypass switch that is not illustrated,
a shunt flexible alternating current transmission systems apparatus, not illustrated, of STATCOM type that is connected at the point of common coupling,
a damping controller that is designed to modulate the voltage reference of the AC voltage controller of the shunt flexible alternating current transmission systems apparatus.

In this installation 1, the damping controller input comprises an active power injected to the system at the point of common coupling at the wind farm 10.

FIG. 2 shows the simulated variation of the current from the rotor 501 and from the stator 502 of the wind farm generator before and after the bypass switch on the series capacitor is opened. In this figure, the stator current 501 and the rotor current 502 are respectively illustrated in thick and thin lines.

This figure shows the effective mitigation of oscillation that is clearly demonstrated on the rotor current. With this simulation, it is possible to conclude that a small signal stability assessment as the rotor current can be used to analyze sub-synchronous oscillation, that in doubly fed induction generator equipped wind farms the sub-synchronous interaction are mainly due to the induction generator effect (oscillation observed on the stator current), and that a simple damping controller included in a Shunt FACTS Apparatus connected at the point of common coupling is capable of damping out sub-synchronous oscillations.

### EXAMPLE 2

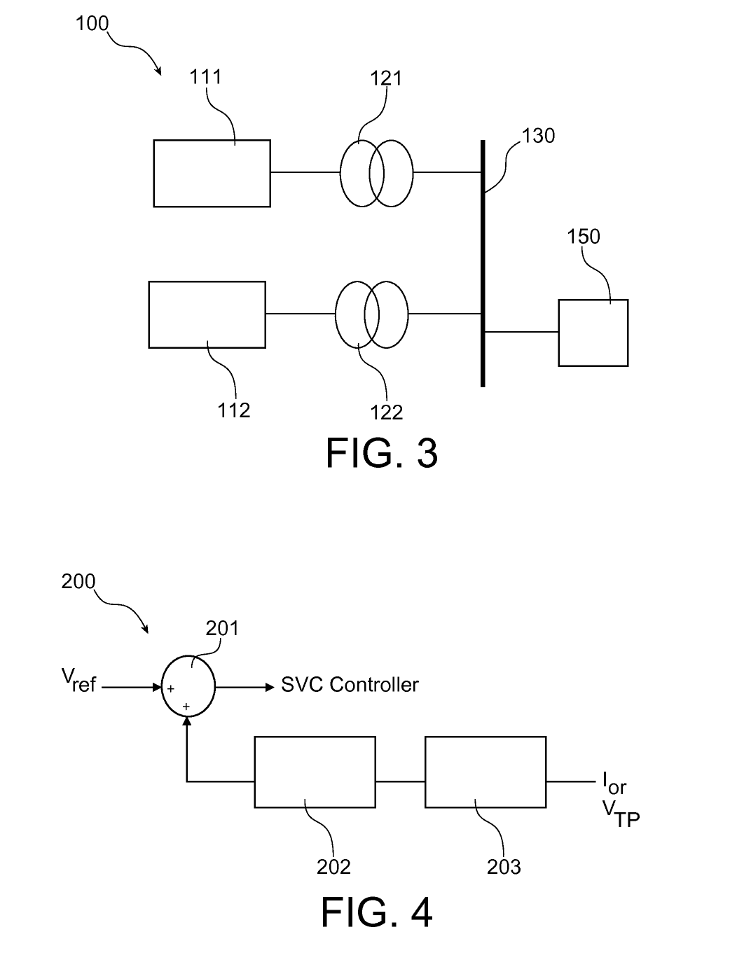

### A Complex Installation as Illustrated in FIG. 3

FIG. 3 illustrates a second installation 100 that comprises a power distribution system according to the invention. This installation 100 comprises:
a first wind farm 111 that comprises doubly fed induction wind generators,
a first point of common coupling transformer 121 connected to the first wind farm 111,
a 345 kV point of common coupling 130 of a high voltage bus that is connected to the first point of common coupling transformer 121,
a static VAR compensator 150 that is installed at the high voltage 345 kV point of common coupling 130, the static VAR compensator 150 comprising at least a capacitor,
a second wind farm 112 that comprise wound rotor with external resistor wind generators,
a second point of common coupling transformer 122 that connects the second wind farm to the 345 kV point of common coupling.

The first and the second wind farm form respectively a first and a second power generation system that comprise wind generators.

The simulation of this installation has been conducted to investigate the possibility of utilizing a shunt flexible AC transmission apparatus (in this case, an SVC-Static VAR Compensator) to mitigate the wind farm series capacitor sub-synchronous interaction in a real system.

During this investigation, it has been observed that the introduction of an SVC with typical controller parameters does not show any improvement of damping in the sub-synchronous interaction mode. But it was also found that the Static VAR compensator terminal voltage measuring time constant and the voltage control proportional gain have a slight impact on the sub-synchronous interaction mode damping. By tuning those parameters it has been observed that it was possible to improve the damping by about 1%.

By adding a damping loop 200 to the static VAR compensator, a much significant improvement of damping can be achieved. Such damping loop 200 is illustrated on FIG. 4. The damping loop 200 comprises a band pass filter 203, a signal delay or advance block 202 and a voltage adder 201. The signal input of the damping loop 200 can be the power or the current flowing through the first point of common coupling transformer 121. It has been found that it is possible to produce superior performance by using current flowing through the first point of common coupling transformer 121 instead of its power. The output of the damping controller is adding to the static VAR compensator controller voltage reference.

By the addition of the damping controller to the static VAR compensator it is possible to improve the subs-synchronous interaction mode damping by approximately 5% without any significant tuning of the controller. With such damping controller and a fine tuning of controllers it is possible to achieve better performance.

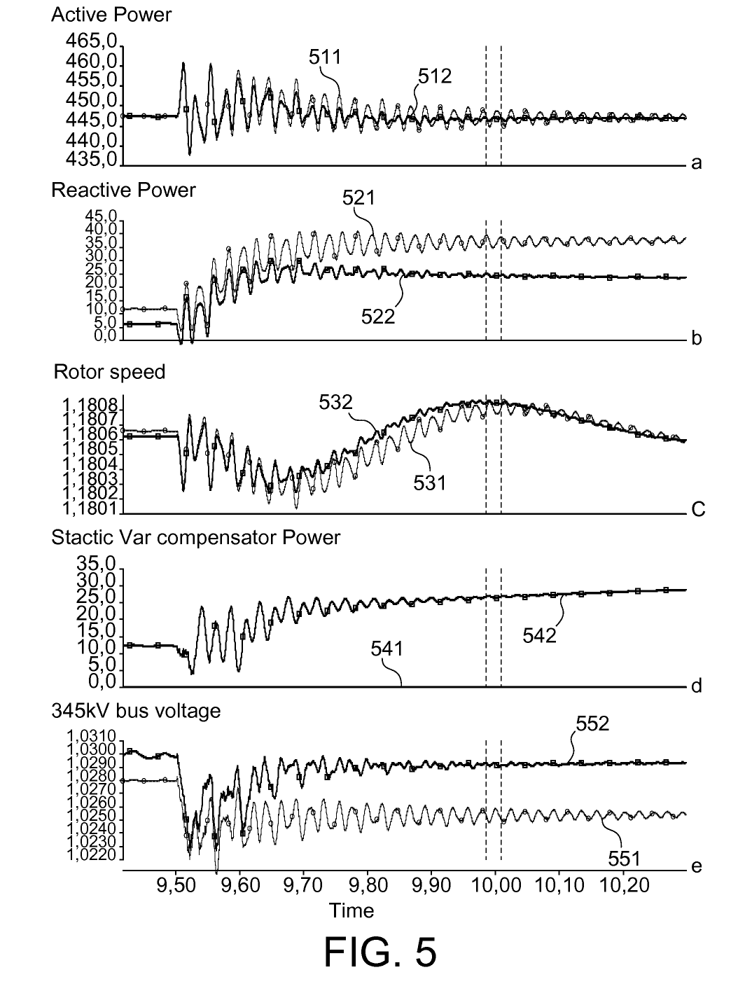

The simulation results of this installation that comprises a damping controller in accordance to the invention are illustrated on FIGS. 5a to 5e. The FIGS. 5a to 5e respectively illustrate the active power 511, 512, the reactive power 521, 522, the rotor speed 531, 532, the static VAR compensator power 541, 542 and the 345 kV bus voltage 551, 552 variations with, thick lines 512, 522, 532, 542, 552, and without, thin lines 511, 521, 531, 541, 551, a static VAR compensator according to the inventions.

The FIGS. 5a to 5e clearly show the improvement in the damping of the oscillatory modes of the system that is due to the adding of the static VAR compensator in accordance to the invention.

These two simulated installations 1, 100 and the simulated measurements show that the use of a Shunt Flexible AC transmission system Apparatus, as an Enhance Static VAR compensator with Damping Controller, can be effective in damping potential sub-synchronous oscillations due to the interaction of series capacitor banks and wind farm generators.

This solution are cost effective, compared to prior art methods as it is strategically located near the affected wind farm generators and thus making it a universal independent solution method that can be implemented in a transmission system even after all other equipment, like series capacitor banks and wind farms, are installed.

1. A power distribution system comprising:
a point of common connection that receives electric power supplied by a first power generation system and a second generation system, wherein the second power generation system comprises a renewable electric power generator;
a transmission line operatively connected to the point of common connection for conducting the electric power between the point of common connection and an external AC electric network;
a capacitive compensator connected in series with the transmission line to compensate for a reactive power component of the electric power conducted by the transmission line; and
a shunt arranged flexible AC transmission system that mitigates a sub-synchronous resonance effect caused at least in part by the capacitive compensator, wherein a flexible AC transmission system controller comprises a damping effect on sub-synchronous oscillations included in the sub-synchronous resonance.

2. The power distribution system of claim 1, wherein the damping component is integrally formed as part of the flexible AC transmission system controller.

3. The power distribution system of claim 1, wherein the flexible AC transmission system controller is a static VAR compensator or a static synchronous compensator.

4. The power distribution system of claim 3, wherein the flexible AC transmission system controller is the static VAR compensator, and the damping component comprises a damping loop that:
(iv) Receives, as an input, a signal indicative of the electric power supplied by at least one of the first and second power generator system,
(v) Performs a comparison of the signal to a reference signal, and
(vi) Transmits an output signal based on the comparison to the static VAR compensator.

5. The power distribution system of claim 1, wherein the damping component establishes a damping ratio of at least about 3%.

6. A shunt-arranged flexible AC transmission system controller comprising:
a resonance component that mitigates a sub-synchronous resonance effect caused at least in part by a capacitive compensator electrically connected, in series, to a transmission line; and
a damping component that imparts a damping effect on sub-synchronous oscillations included in the sub-synchronous resonance that have frequencies less than a fundamental frequency of the electric power conducted by the transmission line.
